(19) United States
(12) Patent Application Publication
(10) Pub. No.: US 2002/0135611 A1
(43) Pub. Date: Sep. 26, 2002

(54) Remote performance management to accelerate distributed processes

(76) Inventors: Trevor Deosaran, Morgan Hill, CA (US); Ram Prabhakar, San Jose, CA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 09/750,013

(22) Filed: Dec. 29, 2000

Related U.S. Application Data
(63) Continuation-in-part of application No. 09/286,289, filed on Apr. 6, 1999.
(63) Continuation-in-part of application No. 09/262,049, filed on Mar. 4, 1999, now abandoned.
(60) Provisional application No. 60/173,517, filed on Dec. 29, 1999.

(51) Int. Cl. G06T 13/00

(52) U.S. Cl. 345/738

(57) ABSTRACT

An intelligent memory system, method, and computer program product for enabling stand-alone or distributed client-server software applications to operate at maximum speeds on a personal computer and the like. An intelligent memory (IM) allows the acceleration of computer software processes through process virtual memory, application optimization, multiprocessor control, and system strategies. The IM includes both control logic and memory. The control logic uses an application database and system database to determine a set of modifications to the computer, application, and/or operating system, while the memory stores the application and allows the control logic to implement the set of modifications. A remote performance management system is also described which allows an IM service provider to supply the infrastructure to clients (e.g., e-businesses and the like who run World Wide Web servers) to facilitate and accelerate their content offerings to end user clients (i.e., consumers).

### CROSS-REFERENCE TO OTHER APPLICATION

This application claims priority to U.S. Provisional Patent Application Serial No. 60/173,517, filed Dec. 29, 1999, and is a continuation-in-part of U.S. patent application Ser. No. 09/286,289, filed Apr. 6, 1999, which is a continuation-in-part of U.S. patent application Ser. No. 09/262,049, filed Mar. 4, 1999, each of which is incorporated herein by reference in its entirety.

### BACKGROUND OF THE INVENTION

1. Field of the Invention

The present invention relates generally to computer software applications, and more particularly to managing and optimizing the processing speed of executing software applications.

2. Related Art

Within the computer industry, it is common for technological advances to cause processor chip speeds to increase at a fast pace—consider, for example, the observation of Moore's Law. The development of software technology, however, has not kept pace with processor speed increases. Thus, when speaking of microprocessors within personal computers, for example, there currently exist many software application technologies that cannot take advantage of the increases in performnce of the processor chips. The above-stated disparity does not manifest itself as a problem in general (i.e., computer) system performance, but rather application performance. That is, today's advanced processor chips are executing instructions at a faster pace, yet this increase in speed is not being passed on to software applications.

The above-mentioned problem demonstrates itself in two ways. First, the actual operation speed of a particular software application, even when executed on a faster processor, does not improve. This is due to the increased complexity of today's software applications and the fact that operating systems are now handling more processes less efficiently than before. Second, there has been a lack of technological advances in software applications that require low latency operations. For example, the Intel® Pentium® Pro processor can do more multiple operations faster than many currently-available graphics chips. These graphics chips, however, are currently required to achieve good graphics performance. This is because the increased performance of the Intel® Pentium® processors and the like are not passed on to the software applications that require it. These processor cycles are unnecessarily wasted.

While there currently exist many performance enhancement products, such as PerfMan® available from Information Systems Manager, Inc. of Bethlehem, Pa., and Wintune™ available from the Microsoft Corporation of Redmond, Wash., these do not address the above-identified needs. Many performance management products simply allow users to change the priority or CPU time slice of an application in a brute-force manner without any intelligence. Typical PC-users, however, do not comprehend such concepts. Further, with the complexity of operating systems increasing, most software applications are written to include a large amount of system calls to the operating system (OS). Thus, increasing an application's priority takes away CPU cycles from the OS and the end result is a degradation of performance—not an enhancement. Also, many processes are slowed while waiting for input/output (I/O). Thus, simply increasing CPU time slices does not help efficiency (i.e., it does not address the problem).

Therefore, what is needed is a system, method, and computer program product for intelligent memory to accelerate processes that allows software applications, both stand-alone and those distributed in a client-server model, to fully utilize the speed of modern (and future) processor chips. The intelligent memory would function in a computing environment where the OS and processors are fixed (i.e., where optimization is not under the control of the PC end-user). Such a system, method, and computer program product would enable software applications to operate at maximum speeds through the acceleration of, for example, context switching and I/O interfacing.

### SUMMARY OF THE INVENTION

The present invention is directed towards a system, method, and computer program product for intelligent memory to accelerate processes that meets the above-identified needs and allows software applications to fully utilize the speed of modem processor chips.

The system includes a graphical user interface, accessible via a user's computer, for allowing the user to select applications executing on the computer to accelerate, an application database that contains profile information on the applications, and a system database that contains configuration information about the computer's configuration. The system also includes an intelligent memory, attached to the computer's system bus as a separate chip or to the processor itself, includes control logic that uses the application database and the system database to determine a set of modifications to the computer, application, and/or operating system. The intelligent memory also includes a memory which stores the executing applications and allows the control logic to implement the set of modifications during execution. The system thereby allows applications to more fully utilize the power (i.e., processing capabilities) of the processor within the computer.

In an embodiment of the present invention, a remote performance management (RPM) system, method and computer program product is also provided which allows an “Intelligent Memory service provider” to supply the infrastructure to clients (e.g., e-businesses and the like who run World Wide Web servers) to facilitate and accelerate their content offerings to end user clients (i.e., consumers).

The RPM system includes an RPM server which, in an embodiment, contains an application database that stores profile information on applications that execute within the computer network and a system database that stores configuration information about the client computers within the computer network. The RPM server contains control logic that uses the application database and the system database to determine a set of modifications for a particular client running a particular application. Upon a request from either a content server or a client machine, the RPM server is capable of connecting to the client computer and downloading data from the application database and aportion of the control logic (i.e., system software) that allows the client computer to make the predetermined set of modifications. As a result of the modifications, the application can more fully utilize the processing capabilities of the nodes within the computer network.

The RPM method and computer program product of the present invention, in one embodiment, includes the RPM server receiving a selection input from a user (e.g., a network administrator) via a graphical user interface. Such a selection would specify a client within the computer network and an application that executes within the computer network. Then, the application database that contains profile data on the application and the system database that contains configuration data about the client within the computer network is accessed. Next, the control logic stored on the RPM server uses the application data and the system data to determine a set of modifications. Then, the RPM server connects to the client and downloads the application data and a portion of the control logic in a form of an applet. At this point, the client can apply the control logic to make the set of predetermined modifications thereby allowing the application to more fully utilize the processing capabilities of the nodes within the computer network. In an embodiment, the above process is repeated in an iterative process and monitored by the RPM server until the desired performance is obtained.

One advantage of the present invention is that it provides a reduced-cost solution for Windows 95/98™ or NT™/Intel® systems (and the like) currently requiring special purpose processors in addition to a central processor.

Another advantage of the present invention is that it allows special purpose computing systems to be displaced by Windows 95/98™ or NT™ based systems (and the like) at a better price-to-performance ratio.

Another advantage of the present invention is that it makes performance acceleration based on run-time information rather than conventional operating system static (i.e., high, medium, and low) priority assignments. Further, the present invention allows users to achieve run-time tuning, which software vendors cannot address. The present invention operates in an environment where compile-time tuning and enhancements are not options for end-users of commercial software applications.

Yet another advantage of the present invention is that it makes performance acceleration completely transparent to the end user. This includes such tasks as recompiling, knowledge of processor type, or knowledge of system type.

Yet still another advantage of the present invention is that it makes performance acceleration completely independent of the end-user software application. This includes recompiling, tuning, and the like.

Yet still another advantage of the present invention is that it allows performance acceleration of stand-alone computer software applications, as well as client-server software applications executing in a distributed fashion over a network.

Another advantage of the present invention is that it provides a remote performance management system where a network manager can configure some of the machines (i.e., nodes) in the network to be efficient, while other machines remain dedicated to some other task.

Further features and advantages of the invention as well as the structure and operation of various embodiments of the present invention are described in detail below with reference to the accompanying drawings.

### BRIEF DESCRIPTION OF THE FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram of a conventional personal computer circuit board (i.e., motherboard);

FIG. 2 is block diagram of a conventional personal computer motherboard simplified according to an embodiment of the present invention;

FIG. 3 is a block diagram illustrating the operating environment of the present invention according to an embodiment;

FIG. 4 is a flow diagram representing a software application executing within the environment of the present invention;

FIG. 5 is a flow diagram illustrating the overall operation of the present invention;

FIG. 6 is a flowchart detailing the operation of the intelligent memory system according to an embodiment of the present invention;

FIGS. 7A-7C are window or screen shots of application performance tables generated by the graphical user interface of the present invention;

FIG. 8 is a block diagram of an exemplary computer system useful for implementing the present invention;

FIG. 9 is a flow diagram illustrating the conventional client-server traffic flow;

FIG. 10 is a block diagram illustrating, in one embodiment, the remote performance management system architecture of the present invention;

FIG. 11 is a flow diagram illustrating the overall remote performance management operation of the present invention; and

FIG. 12 is a flow diagram illustrating, according to an embodiment, the IP Authentication function of the present invention's Remote Performance Management system.

### DETAILED DESCRIPTION OF THE PREFERRED EMBODIMENTS

### Table Of Contents

I. Overview

II. System Architecture

III. System Operation

A. Dataflow

B. Methodology

C. Graphical User Interface

IV. Accelerations

A. Specific Accelerations

B. General Strategies

V. Client-Server Applications

VI. Remote Performance Management

A. Overview and Business Model

B. RPM Architecture

C. Example Implementations

D. Remote Authentication

E. Remote Application Reconfiguration

F. Remote Operating System Reconfiguration

G. Secure Machine to Machine Communication

H. Remote Machine Reconfiguration

VII. Example Implementations

VIII. Conclusion

I. Overview

The present invention relates to a system, method, and computer program product for intelligent memory to accelerate processes that allows software applications to fully utilize the speed of modem (and future) processor chips. In an embodiment of the present invention, an intelligent memory chip is provided that interfaces with both the system bus and the peripheral component interconnect (PCI) bus of a computer's circuit board (i.e., motherboard). In alternative embodiments, the intelligent memory chip of the present invention may be connected to the motherboard in a variety of ways other than through the PCI bus.

The present invention also includes control software, controllable from a graphical user interface (GUI), and a database of applications and system profiles to fine tune a user's computer system to the requirements of the software application and thus, increase the performance of the applications running on the computer system.

The present invention's intelligent memory enables software applications to operate at maximum speeds through the acceleration of context switching and I/O interfacing. The acceleration of context switching includes software-based acceleration of application programs, processes-based caching acceleration of application programs, real-time code modification for increased performance, and process-specific multiprocessing for increased performance. The acceleration of I/O interfacing includes memory access acceleration and digital-to-analog (D/A) conversion acceleration.

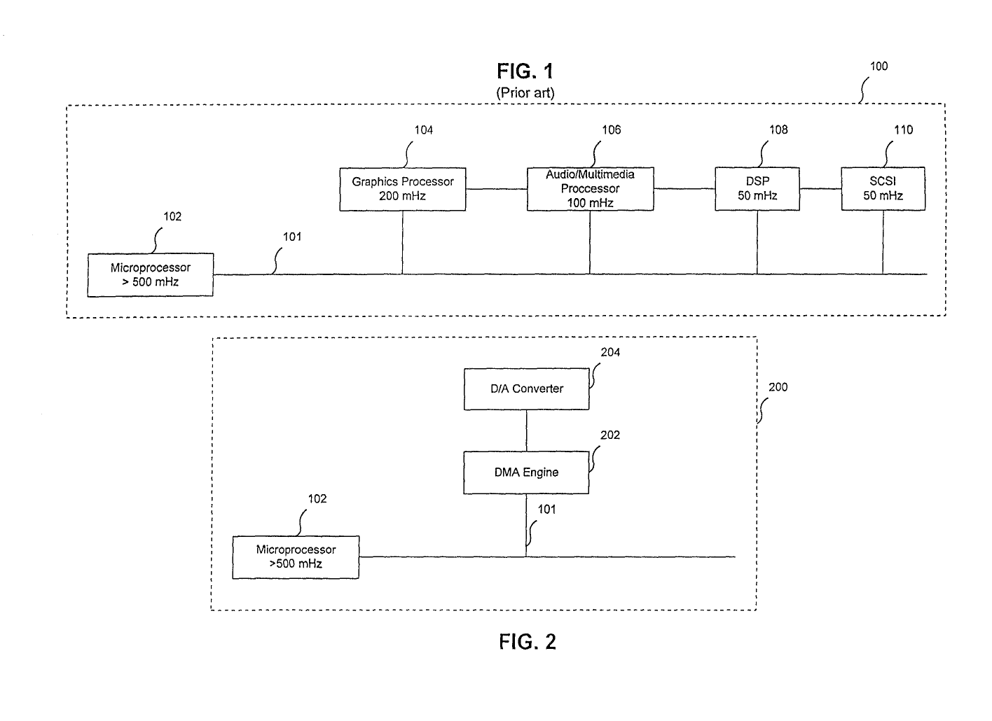

It is a major objective of the present invention, through the accelerations mentioned above, and as will be described in detail below, to provide a reduced-cost solution for Intel® processor-based, IBM™ compatible personal computers (PCs), running the Windows 95/98™ or Windows NT™ operating system, which currently require a central processor as well as special purpose processors. This objective is illustrated by juxtaposing FIG. 1 and FIG. 2.

Referring to FIG. 1, a (simplified) block diagram of a conventional PC motherboard 100 is shown. Motherboard 100 includes a microprocessor 102 which typically operates at a speed of at least 500 Megahertz (MHZ), a special graphics processor (i.e., graphics card) 104 which typically operates at a speed of at least 200 MHZ, and an audio or multimedia processor 106 (e.g., a sound card) which typically operates at a speed of at least 100 MHZ. The motherboard 100 also includes a digital signal processing (DSP) card 108 and a small computer system interface (SCSI) card 110, both of which typically operate at a speed of at least 50 MHZ. As will be apparent to one skilled in the relevant art(s), all of the components of the motherboard 100 are connected and communicate via a communication medium such as a bus 101.

A PC equipped with motherboard 100 utilizes the plurality of special-purpose cards (e.g., cards 104, 106, 108, and 110) to communicate with different I/O devices and to speed-up processing during the course of executing certain software applications. Without the presence of these special-purpose cards, the OS is required to switch between running a software application and running an I/O device (e.g., graphics driver) connected to the PC, which the application is dependent upon for proper execution. Most operating systems, however, are not capable of doing this (context) switching at a speed fast enough to satisfy PC users who demand “quick” response times from their computer systems. Real-time operating systems, such as TrueFFS for Tornado™ provided by Wind River Systems of Alameda, Calif,, offer such fast switching. However, such real-time operating systems are “high-end” products not within the grasp of average PC users running the Windows 95/98™ or Windows NT™ operating systems. Thus, the need for special-purpose cards represents added expenses for the PC user.

Referring to FIG. 2, a block diagram of a PC motherboard 200, simplified according to an embodiment of the present invention, is shown. Motherboard 200, when juxtaposed to motherboard 100 (as shown in FIG. 1), reveals that it includes solely the microprocessor 102, a direct memory access (DMA) engine 202, and a D/A converter 204, which are connected and communicate via bus 101. The DMA engine 202 can be any component (e.g., a dumb frame buffer) that allows peripherals to read and write memory without intervention by the CPU (i.e., main processor 102), while the D/A converter 204 allows the motherboard 200 (and thus, the PC) to connect to a telephone line, audio source, and the like. The simplified motherboard 200, as will become apparent after reading the description below, is made possible by the insertion and use of the present invention's intelligent memory system. Motherboard 200 illustrates the how the present invention can displace special-purpose computing systems to yield the PC-user a better price-to-performance ratio.

The present invention, as described herein, can eliminate “minimum system requirements” many software vendors advertise as being needed to run their products. In one embodiment, the intelligent memory of the present invention can come pre-packaged for specific hardware and/or software configurations. In another embodiment, the present invention may come as a plug in software or hardware component for a previously purchased PC.

Several existing products attempt to make the entire computer system more efficient. That is, some products attempt to balance the CPU power more evenly and others attempt to eliminate operating system waste of resources. These schemes can generally be described as attempting to divide the computer system's resources in a “fair” fashion. That is, the existing optimizing software products seek to balance resources among all processes.

The present invention, however, is intended for the “unfair” distribution of a systems resources. That is, the resources are distributed according to the wishes of the user (which are entered in a simple, intuitive fashion) at run-time. This is done via a performance table, where the processes at the head of the table are “guaranteed” to get a larger portion of system resources than processes lower in the table.

The present invention is described in terms of the above examples. This is for convenience only and is not intended to limit the application of the present invention. In fact, after reading the following description, it will be apparent to one skilled in the relevant art(s) how to implement the following invention in alternative embodiments. For example, the intelligent memory can be implemented using strictly software, strictly hardware, or any combination of the two.

Furthermore, after reading the following description, it will be apparent to one skilled in the relevant art(s) that the intelligent memory system, method, and computer program product can be implemented in computer systems other than Intel® processor-based, IBM compatible PCs, running the Windows 95/98™ or Windows NT™ operating systems. Such systems include, for example, a Macintosh® computer running the Mac® OS operating system, the Sun® SPARC® workstation running the Solaris® operating system, or the like. In general, the present invention may be implemented within any processing device that executes software applications, including, but not limited to, a desktop computer, laptop, palmtop, workstation, set-top box, personal data assistant (PDA), and the like.

II. System Architecture

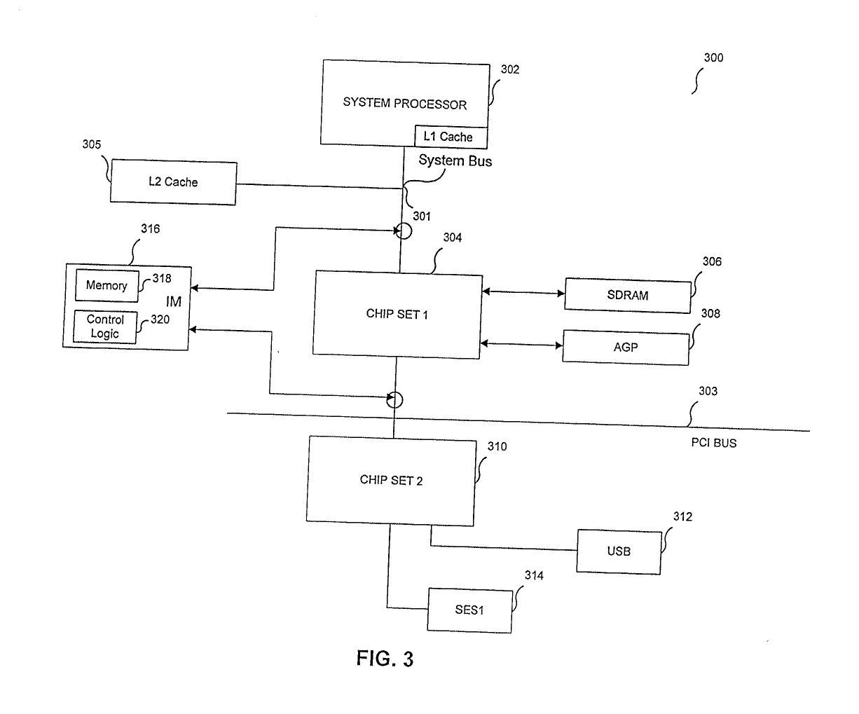

Referring to FIG. 3, a block diagram (more detailed than FIG. 1 and FIG. 2) illustrating a motherboard 300, which is an operating environment of an embodiment of the present invention, is shown. Motherboard 300 is a conventional PC motherboard modified according to the present invention. Motherboard 300 includes a system processor 302 that includes a level one (L1) cache (i.e., primary cache), and a separate level two (L2) cache 305 (i.e., a secondary external cache). Motherboard 300 also includes a first chip set 304, which is connected to a Synchronous Dynamic Random Access Memory (SDRAM) chip 306 and an Accelerated Graphics Port (AGP) 308. All of the above-mentioned components of motherboard 300 are connected and communicate via a communication medium such as a system bus 301.

Further included in motherboard 300 is second chip set 310 that is connected and communicates with the above-mentioned components via a communication medium such as a PCI bus 303. Connected to the second chip set 310 is a universal serial bus (USB) 312 and SCSI card 314. All of the above-mentioned components of Motherboard 300 are well known and their functionality will be apparent to those skilled in the relevant art(s).

The present invention, however, also includes an intelligent memory 316 (shown as “IM” 316 in FIG. 3). As indicated in FIG. 3, the IM 316 has access to both the system bus 101 and PCI bus 303 which allows, as will be explained below, both context switching and I/O interfacing-based accelerations. The IM 316 includes a configurable and programmable memory 318 with intelligent control logic (i.e., an IM processor) 320 that speeds execution of application software without the need for special processor cards as explained above with reference to FIGS. 1 and 2. The functionality of the IM 316 is described in detail below.

While the configurable and programmable memory 318 and the intelligent control logic 320 are shown as one component 316 in FIG. 3, it will be apparent to one skilled in the relevant art(s) that they may physically be, in an alternative embodiment, two separate components.

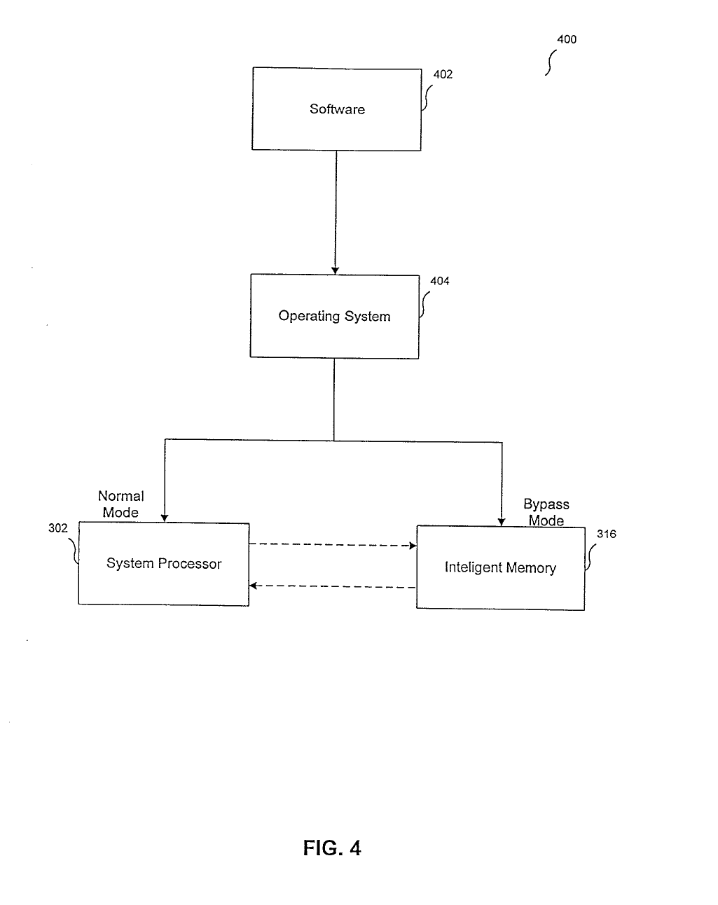

Referring to FIG. 4, a flow diagram 400 representing a software application executing within the environment of the present invention is shown. That is, a software application 402 can be made to run faster (i.e., be accelerated) on a PC modified by the presence of the IM 316 (as shown, for example, in FIG. 3). Flow diagram 400 illustrates the software application 402 running on top of a PC's operating system 404 in order to execute. In an embodiment of the present invention, the software application 402 may then be run in one of two modes.

The first mode is “normal” mode where the system processor 302 functions as a conventional processor in order to execute the application. The second mode, according to the present invention, is a “bypass” mode where the IM 316 interacts with the system processor 302 in order to accelerate the execution of the software application 402. The acceleration and interaction of the bypass mode, as performed by the IM 316, is described in more detail below.

III System Operation

A. Dataflow

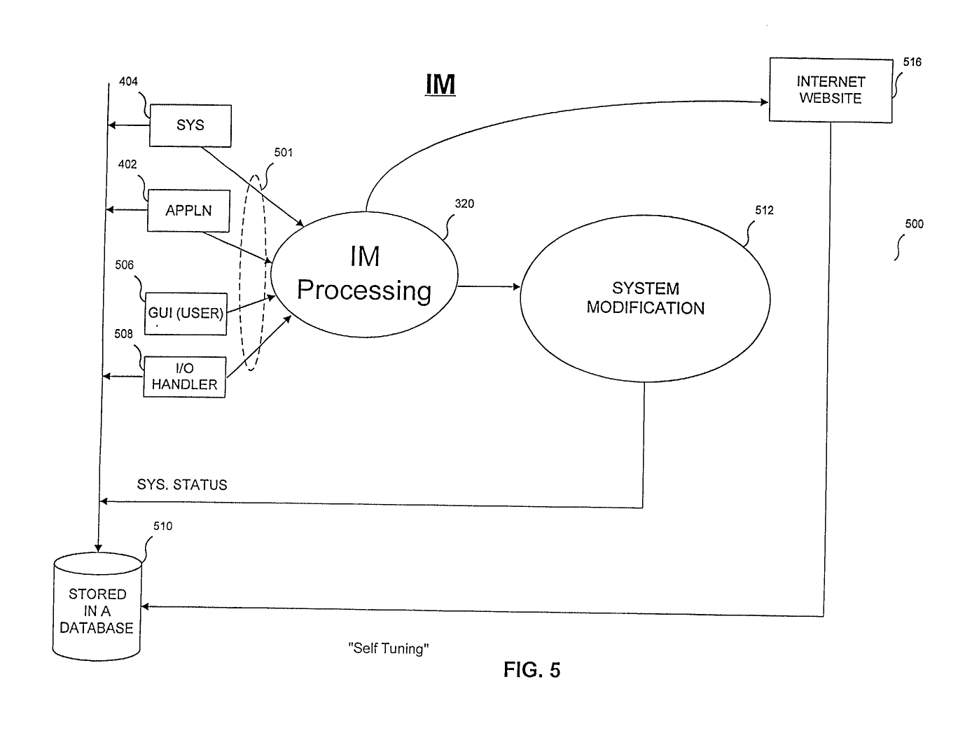

Referring to FIG. 5, a dataflow diagram 500 illustrating the overall operation of the IM 316 is shown. The IM 316 functions by taking inputs 501 from: (1) the OS 404; (2) the software application(s) 402 being accelerated; (3) the user via a GUI 506; and (4) an I/O handler 508 located on the PC. The four inputs are processed at run-time by the IM processor 320 in order to affect system modifications 512. Once the modifications 512 are made, the IM 316 receives system status in order to monitor the progress of the running software application 402. The system status information, as explained in detail below, will be used by the IM processor 320 to determine if additional system modifications 512 will be necessary in order to accelerate the software application 402 according to the wishes of the user (i.e, input from GUI 506).

In an embodiment of the present invention, a database 510 collects the inputs 501 and the system status information so that a history of what specific modifications 512 result in what performance improvements (i.e., accelerations) for a given software application 402. This allows the IM 316 to become “self-tuning” in the future when the same software application 402 is run under the same system conditions (i.e., system status). Further, by collecting the history of the modifications that increase performance, software vendors may examine database 510 in the process of determining the enhancements to implement in new releases of software applications 402.

In an embodiment of the present invention, the database 510 would initially contain, for example, known characteristics for the ten most-popular operating systems and ten most-popular software applications. For example, the database 510 may include information indicating that if the application 402 is the Microsoft™ Word word processing software, that the screen updates and spell-checker functions are more important to accelerate than the file-save function. As will be apparent to one skilled in the relevant art(s), the physical location of the database 510 is unimportant as long as the IM 316 may access the information stored within it without adding delay that would destroy any performance benefit achieved by IM processing 320.

Aside from collecting the inputs 501 and the system status information so that a history of what modifications 512 yield performance improvements, the database 510 also contains specific application and system information to allow the control logic (i.e., IM processor 320) of IM 316 to make initial system modifications 512. The information included in the database 510 can be categorized into: (1) system status information; and (2) application information. While one database 510 is shown in FIG. 5 for ease of explanation, it will be apparent to one skilled in the relevant art(s), that the present invention may utilize separate application and system databases physically located on one or more different storage media.

The system information within the database 510 contains information about the specific configuration of the computer system. In an embodiment of the present information, some of this information is loaded at setup time and stored in a configuration file while other information is determined every time the bypass mode of the IM 316 is launched. The system information within the database 510 can be divided into four organizational categories—cache, processor, memory, and peripheral. These four organizational categories and the classes of system information within database 510, by way of example, are described in TABLES 1A-1D, respectively.

TABLE 1A

| CACHE ORGANIZATION | |
|---|---|
| CLASS OF INFORMATION | DESCRIPTION |
| Cache Level | The levels in the cache (1,2,3,4) |
| Location | The location of the cache level (e.g., |
| | Processor_Die, Processor_Module, |
| | System_Bus IO_BUS) |
| Size | Indicates the cache size for the particular |
| | level (a size field of 0 indicates the cache |
| | level is non existent) |
| Protocol | Indicates which cache protocol is used at |
| | which level. The cache protocol consists |
| | of the transition states of the cache |
| | (MOESI protocol). The MOESI |
| | (Modified, Owned, Exclusive, Shared, |
| | Invalid) state transition diagram |
| | determines the policy the cache level uses |
| | to handle blocks. In this field the value |
| | would indicate the transitions used. |
| | NOTE: The state transitions are usually |
| | unique to a particular processor model, but |
| | this field is included in case there are any |
| | issues. |
| Associativity | Indicates the associativity of the cache |
| | level. The field indicates the way of the |
| | associativity. A value of 0 indicates a fully |
| | associative cache organization. |
| Replacement Strategy | Indicates which block will be removed to |
| | make room for a new block. This field |
| | indicates which type of strategy is used. |
| | Examples of replacement strategies are |
| | (1) LRU (least recently used) (2) FIFO |
| | (first in first out) (3) Random. There are |
| | also modified versions of these algorithms. |
| Cache Type | A spare field to indicate any special types |
| | of caches which may be required. |

The fields, presented in TABLE 1B, indicate the different attributes of the processor 302 stored within the database 510. It should be noted that the differences in processors may be indicated by vendor and model number, but these variations are indicated to allow the software to make decisions based on processor architecture rather than model numbers.

TABLE 1B

| PROCESSOR ORGANIZATION | |
|---|---|
| CLASS OF INFORMATION | DESCRIPTION |
| Clock Speed | Indicates the clock speed of the |
| | processor. There are sub-fields to |
| | indicate the clock speeds for the |
| | CPU, and the different cache level |
| | interfaces. |
| Superscalar | Indicates the type of superscalar |
| | organization of the central processing |
| | unit. |
| Vendor | Indicates the vendor and model |
| | number of the processor. |
| Special Instructions | Indicates the availability and types of |
| | special instructions. |

This section of the database, as shown in TABLE 1C, indicates the structure of the memory sub-system of the PC.

TABLE 1B

| PROCESSOR ORGANIZATION | |
|---|---|
| CLASS OF INFORMATION | DESCRIPTION |
| Pipelining | Indicate the level of pipelining of the |
| | accesses to memory. It also indicates |
| | the pipelining of reads and writes. |
| Bus protocol | Indicates the type of bus used to |
| | connect to main memory |
| Types | Indicates the type of memory the |
| | main memory is composed of. |
| Vendors | Lists the vendors and model numbers |
| | of the main memory modules. There |
| | are also sub-fields indicating the |
| | vendor and model of the memory |
| | chips. |
| Speed | Indicates the speed of the memory |
| | sub-system. |

This section of the database 510, as shown in TABLE 1D, contains information on the peripheral organization and type of the I/O sub-system of the PC.

TABLE 1D

| PERIPHERAL | |
|---|---|
| ORGANIZATION | |
| CLASS OF INFORMATION | DESCRIPTION |
| I/O Bus Type | Indicates the types of busses used to |
| | connect to the I/O peripherals (e.g., |
| | PCI, AGP of ISA) |
| I/O Control Mechanism | Indicates the type of control mechanism |
| | the I/O uses. For most peripherals this |
| | is memory mapped registers, but some |
| | PCs use other types of control |
| | mechanisms. These may be I/O mapped |
| | control registers or memory queues. |
| Special Purpose Functions | Indicates some special functions |
| | performed by the I/O. The actual value of |
| | this field depends on the vendor of the |
| | I/O peripheral. |
| Non-cache Regions | Indicates the non-cacheable regions of the |
| | memory space used by the I/O sub-system. |
| Control Libraries | Indicates the locations and types of the |
| | drivers of the I/O peripherals. |

The system information within database 510 can be populated with such system configuration data using any system manager function (e.g., reading the system's complementary metal oxide semiconductor (CMOS) chip, reading the Registry in a Windows 95/98™ environment, etc.).

The application information within database 510 contains the performance related information of specific applications 402. If the user selects any of these applications 402 to accelerate, the IM control logic 320 will retrieve this information from the database 510 to optimize the application 402. The classes of application information within database 510, by way of example, are described in TABLE 2.

TABLE 2

| CLASS OF | |
|---|---|
| INFORMATION | DESCRIPTION |
| Page Usage Profile | The profile of the virtual memory page accesses. |
| | The page location and frequency of access and |
| | type of access are contained in this section |
| Branch Taken Profile | The taken/not taken frequency of each branch is |
| | mapped into the database. The application |
| | function associated with the branch is also |
| | mapped to the branch location. |
| Superscalar Alignment | The application database also contains |
| Profile | information about the potential for superscalar |
| | re-alignment for different sections of code. |
| | The analysis program looks at long segments of |
| | code for superscalar realignment opportunities |
| | and indicates these places and the optimization |
| | strategy for the code sequence. |
| Data Load Profile | The database contains information about the |
| | frequency and location of data accesses of the |
| | application. |
| Non-cache Usage | The database contains information on the |
| Profile | frequency and location of non-cached accesses |
| I/O Usage Profile | The database contains information on the |
| | frequency and location of Input Output accesses |
| Instruction Profile | The frequencies of different types of instructions |
| | are stored in the database. These are used to |
| | determine the places where the instructions can be |
| | replaced by more efficient instructions and/or |
| | sequences. |

The application information within database 510 can be populated with such data based on industry knowledge and experience with the use of particular commercial software applications 402 (as explained with reference to FIG. 5 below).

Further, one embodiment of the present invention envisions that each computer system equipped with an IM 316 can be linked to a central Web site 516 accessible over the global Internet. The Web site 516 can then collect information from many other computer systems (e.g., via a batch upload process or the like) and further improve each individuals system's database 516. That is, a wider knowledge base would be available for determining what specific modifications yield specific performance improvements (i.e., accelerations) for a given software application 402 and/or given PC configuration.

In an embodiment of the present invention, an intelligent memory service provider can provide means, via the Web site 516, for users to download updated revisions and new (AI) algorithms of the IM control logic 320 as well as new and updated (system and/or application) information for their local database 510. Information from all users is updated to a central site and this information is used to determine the best possible optimization strategies for increasing performance. The strategies can then be downloaded by users. The result is an ever increasing database of optimization strategies for an ever widening number of configurations.

In an alternative embodiment, users can also obtain a CD ROM (or other media) that contain the latest optimization strategies. Different software manufacturers may also want to distribute specific strategies for their specific applications 402 and thus gain a competitive advantage over their competitors. Other data collection and distribution techniques, after reading the above description, will be apparent to a person skilled in the relevant art(s).

B. Methodology

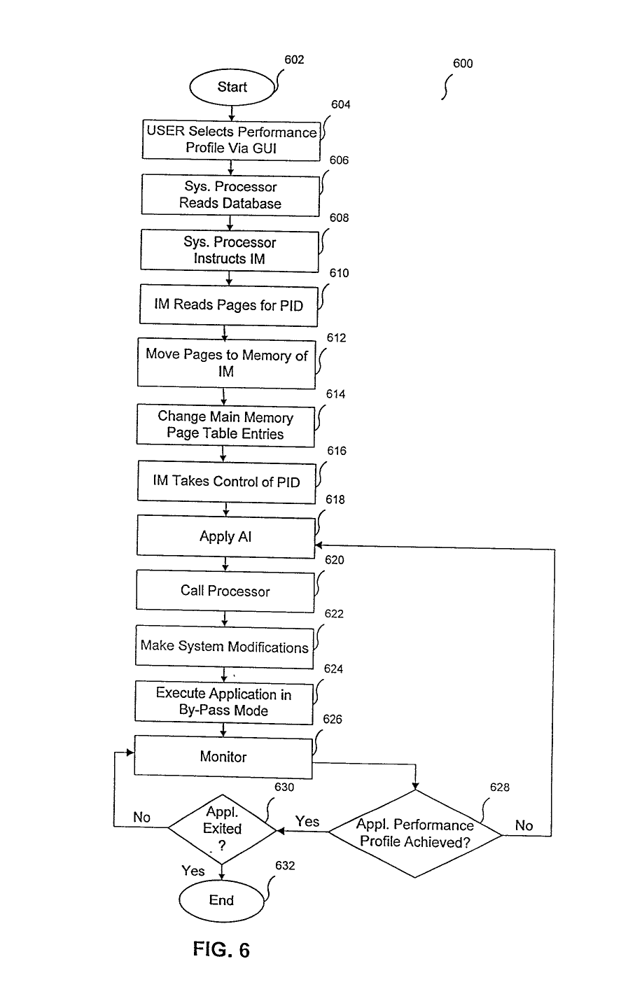

Referring to FIG. 6, a flowchart 600 detailing the operation of a computer system (such as system 300) containing the IM 316 is shown. It should be understood that the present invention is sufficiently flexible and configurable, and that the control flow shown in FIG. 6 is presented for example purposes only. Flowchart 600 begins at step 602 with control passing immediately to step 604. In a step 604, a user, via the GUI 506, selects the software application 402 whose performance they would like to modify and the performance profile they would like the application 402 to achieve. This selection can be made from a list of running process identification numbers (PID).

In one embodiment of the present invention, GUI 506 may be separate window running within the OS of the PC, that provides the user with an interface (radio buttons, push buttons, etc.) to control and obtain the advantages of the intelligent memory 316 as described herein. In another embodiment, the GUI 506 may be configured as an embedded control interface into existing software applications.

In a step 606, the system processor 404 reads the database 510 to obtain the application- and system-specific information needed in order to affect the user's desired performance profile selected in step 604. In a step 608, the system processor then instructs the IM 316 to accelerate the process selected by the user in step 604. The PID of the process is used by the system processor to identify the particular software application 402 to the IM 316.

In a step 610, the IM 316 goes through page table entries in main memory (i.e., in SDRAM 306) for the software application 402 pages using the PID. In a step 612, the pages are moved to the internal memory 318 of the IM 316. In this fashion, the IM 316 functions as a “virtual cache.” In an example embodiment of the present invention, the pages of the application 402 can be stored to the IM 316 in an encrypted fashion to protect the data stored in the IM 316.

In a step 614, the page table entries in the main memory for the PID are changed to point to the internal memory 318 of the IM 316. At this point, the internal memory 318 of the IM 316 contains pages for only the application(s) 402 represented by the PID(s) chosen by the user. This is unlike the main memory, which contains pages for all of the currently running processes.

In a step 616, the IM 316 takes control of the application 402, employing the necessary modifications to accelerate it. Now, when the system processor 302 access main memory during the execution of the application 403, the main memory's address space for the application 402 will point to the IM 316. This allows the IM 316 to operate invisibly from the system processor 302.

In a step 618, the artificial intelligence (AI) (or control logic) contained within the IM processor 320 is applied to the inputs of step 604 and 606 in order to derive the specific system modifications 512 necessary in order to achieve the desired performance profile. Then, in a step 620, the processor is called to update the hardware devices table within the PC and the state at which they boot up (i.e., device enabled or device disabled). The processor does this by reading the device type and its function.

In a step 622, the system modifications determined in step 618 are applied (e.g., modifying OS 404 switches and hardware settings) as indicated in dataflow diagram 500 (more specifically, 512). Then, in a step 624, the specific application 402 is allowed to continue and is now running in the bypass mode (as shown and described with reference to FIG. 3). In a step 626, the IM 316 begins to monitor the progress of the running software application 402. In a step 628, the monitored system status information is used to determine if additional modifications 512 will be necessary in order to accelerate the software application 402 according to the wishes of the user (i.e, inputs from GUI 506 in step 604). If the desired performance profile is not achieved, steps 618 to 626 are repeated as indicated in flowchart 600. If the desired performance profile is achieved, step 630 determines if the application 402 is still executing. As indicated in flowchart 600, steps 626 to 630 are repeated as the application 402 runs in bypass mode until its execution is complete and flowchart 600 ends as indicated by step 632.

As will be apparent to one skilled in the relevant art(s), in an alternative embodiment of the present invention, more than one application 402 can be selected for acceleration in step 604.

C. Graphical User Interface

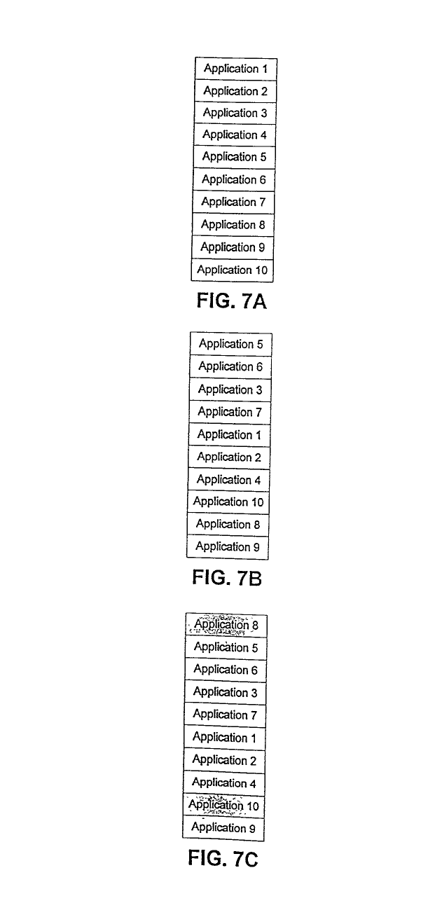

As mentioned above, the GUI 506 accepts a user's input to determine the performance profile and process modifications 512. The GUI 596 can accept user inputs through an application performance table 700 shown in FIGS. 7A-C.

The application performance table 700 is a means of simultaneously displaying relative application 402 performance and accepting the input from the user as to which applications 402 the user wants to accelerate. The application performance table 700 works as follows:

Initially the table 700 is a list of applications, while the initial table is being displayed (i.e., in normal mode), the IM 316 is determining the relative performance of the applications as shown in FIG. 7A. The relative performance is not just CPU usage, but a combination of the relative usage of all system resources. In bypass mode, the IM 316 would then rearranges the table with the applications listed in the order of their relative performance as shown in FIG. 7B.

The user can look at the listing of the relative performance and determine which application they would like to accelerate. The user can then select an application 402 with, for example, a mouse and move the application to a higher position in the table (i.e., “dragging and dropping”). Referring to FIG. 7C, the user has moved Application 8 to the top of the list indicating that they would like application 8 to be the fastest (that is, Application 8 should be allocated the most system resources). The IM 316 will then reassign the system resources to ensure that Application 8 receives the most system resources. Accordingly, the applications 402 that have been moved down the application performance table 700 will receive less system resources when modifications 512 are made.

The present invention's use of the application performance table 700 has several advantages over previous performance control technology as summarized in TABLE 3.

TABLE 3

| | PREVIOUS | TABLE 700 |
|---|---|---|
| CATEGORY | TECHNOLOGY | ADVANTAGE |
| Intuitive | Displayed actual numbers | Displays relative |
| Display | user had to figure out | performance user can see |
| | which resource were a | immediately which |
| | problem | applications have problems |
| Desired | User can change certain | Use indicates required |
| Performance | OS parameters but these | performance, software |
| Input | may not be performance | determines which |
| | bottlenecks | parameters to change and |
| Parameter | Only few options in | by how much |
| Changes | changing few parameters | Software can make many |
| | | subtle changes in many |
| | | parameters |
| Feedback | No feedback | User can see immediate |
| | | feedback of software |

It should be understood that the GUI 506 screen shots shown in FIG. 7 are presented for example purposes only. The GUI 506 of the present invention is sufficiently flexible and configurable such that users may navigate through the system 500 in ways other than that shown in FIGS. 7A-C (e.g., icons, pull-down menu, etc.). These other ways to navigate thought the GUI 506 would coincide with the alternative embodiments of the present invention presented below.

In an alternative embodiment of the present invention, the GUI 506 would allow the user to select differing levels of optimization for an application 402 (e.g., low, normal, or aggressive).

In an embodiment of the present invention, a multi-threaded application 402 can be selected for acceleration. For example, an application 402 can have one initial process and many threads or child processes. The user may select any of these for acceleration depending on which function within the application they desire to accelerate.

Further, in an embodiment of the present invention, a user can select processes within the OS 404 to accelerate (as opposed to merely executing applications 402). This would allow a general computer system performance increase to be obtained. For example, the Windows NT™ and Unix™ operating systems have daemon processes which handle I/O and system management functions. If the user desires to accelerate these processes (and selects them from the a process performance table similar to the application performance table 700), the present invention will ensure that these processes will have the most resources and the general system performance will be accelerated.

IV. Accelerations

A. Specific Accelerations

The control that the IM 316 exhibits over the application 402 is managed by the IM processor 320. The IM processor 320, taking into account the four inputs explained above with reference to data flow diagram 500, and using the database 510, decides what OS 404 switches and hardware settings to modify in order to achieve the acceleration desired by the user. The general approach of the present invention is to consider the computer system, the application 402 targeted for acceleration, the user's objective, and the I/O handler 508. This run-time approach allows greater acceleration of application 402 than possible with design-time solutions. This is because design-time solutions make fixed assumptions about a computer system which, in reality, is in continual flux.

The three types of classes upon which the IM processing 320 of the present invention operates on to make modification 512 are listed in TABLE 4.

TABLE 4

| | | Monitoring and |
|---|---|---|
| Inputs | Execution | Feedback |
| GUI & DB | System | None |
| Hardware Fixed | Special Process in IM 316 | Hardware monitoring |
| GUI & DB | Special Process in IM 316 | Chip-specific Instruction |

The control logic 320 uses the information within database 510 and determines which strategy to use to increase the performance of the system (i.e., the application(s) 402 executing within the computer system). The optimization strategies employed by the IM 316 include, for example, process virtual memory, application optimization, multiprocessor control, and system strategies. Specific examples of each type of optimization strategy are presented in TABLES 5-8, respectively.

TABLE 5

| PROCESS VIRTUAL | |
|---|---|
| MEMORY STRATEGIES | DESCRIPTION |
| Cache Mapping | The location of the process pages are |
| Efficiency | changed to increase the cache hit rate |
| | for that processor. This is called page |
| | coloring |
| Make pages | The process pages are made non-moveable |
| Non-removable | so that the optimal placement will not be |
| | destroyed. This is done by altering the |
| | attributes of the page in the Page Table |
| | Entry. |
| Change TLB to | This strategy involves the replacement of |
| Match Process | TLB entries to ensure that the target process |
| | has all (or as many as possible) entries |
| | cached in the TLB cache. The strategy |
| Process Page | This means the process page is fetched |
| Prefetch | into memory before it is needed. For |
| | optimum performance all the processes pages |
| | are stored in memory and made |
| | non-removable. |

Application optimization strategies, shown in TABLE 6, allow individual applications are also optimized. The strategies involve modifications to actual code and placement of code in the application. The final code and placement is determined by the processor type and memory organization.

TABLE 6

| APPLICATION | |
|---|---|
| OPTIMIZATION | |
| STRATEGIES | DESCRIPTION |
| Loop | In this strategy the instruction sequence in a loop is |
| Modification | modified to be optimal for the prefetch and superscalar |
| | organization of the processor. The cache and memory |
| | organization is also taken into account during the loop |
| | optimizations. |
| Instruction | In this strategy the code of the application is translated |
| translation | to code which is optimal for the type of processor in |
| | the system. |
| Code | The location of the code in memory is also modified |
| placement | for three reasons. |
| | 1) Modification of the code frequently means the code |
| | sequence changes length so that the code sequence has |
| | to be moved for optimal placement. |
| | 2) Many applications have unnecessary space in them |
| | because of linker inefficiencies. The code can be |
| | compacted to take up less room in memory, hence the |
| | performance can be increased. |
| | 3) The code placement is also changed to be optimal |
| | for the cache and memory organization of the system. |

Multiprocessor control strategies, shown in TABLE 7, control the assignment of processes and tasks to different processors in an multiprocessing system. The operating system tries to balance tasks in a multiprocessing system which results in inefficiencies in task execution.

TABLE 7

| MULTIPROCESSOR | |
|---|---|
| CONTROL | |
| STRATEGIES | DESCRIPTION |
| Select processor | The main processor optimization is to fix the |
| for process | process to be executed on only one processor. |

System strategies, shown in TABLE 8, are “miscellaneous” strategies for increasing the performance of the application. These concern setting operating system switches which affect how the operating system handles the application. As will be apparent to one skilled in the relevant art(s), many performance control software applications currently available use these two strategies exclusively.

TABLE 8

| SYSTEM | |
|---|---|
| STRATEGIES | DESCRIPTION |
| Change process priorities | In this strategy the process priority is |
| | changed to a higher value. |
| Modify Time Slice | In this strategy the time slice allocation for a |
| | process is increased. |

B. General Strategies

As explained above, intelligent memory 316 acceleration consists of memory 318 with special mapping. Ordinary L2 caches are based on address mapping. This mapping is a trade-off to reduce cost and complexity. The mapping is based on the location of the cache block in memory. In order to reduce costs even further, several different memory blocks are assigned the same cache location. This means a specific process has to share cache space with other processes. When the OS 404 switches between processes, there is a period of high cache miss rate. Thus, in an embodiment of the present invention, in order to reduce the latency and increase throughput of selected processes, these processes are entirely mapped in the IM 316. Even processes which occupy regions in memory which would have used the same block in the address mapped cache can share the IM 316. Depending on the memory hierarchy organization, the IM 316 can be described as an intelligent cache or reserved memory.

Real-time code modification consists of changing the instruction sequence to increase the performance. There are many well-known techniques for post-compile code modification to increase performance as described in Kevin Dowd, High Performance Computing, ISBN 1565920325, O'Reilly & Associates 1993 (USA), which is hereby incorporated by reference in its entirety. These techniques, however, resolve performance problems at link time. This is because there are many difficulties in modifying the code in real time, such as re-calculating address offsets and re-targeting jumps. Because the present invention contains the entire process address space in the intelligent memory 318, it can easily modify the code and change the locations for optimum efficiency.

Process-specific multiprocessing consists of executing specific processes on different processors. The main processor executes processes as usual, but selected processes are executed on a secondary processor. This is not the same as regular multiprocessing. The multiprocessing is done “in front of” the level-2 cache 305. In the present invention, the intelligent memory 318 has all the code locally and can determine which processor to run a particular process on. The memory 318 can also partition processors among asymmetric processors.

V. Client-Server Applications

In an alternative embodiment, a computer system which includes client-server software applications executing in a distributed fashion within a network is contemplated, whereby the present invention may be utilized.

As is well known in the computing arts, computer software applications are commonly implemented in accordance with a client-server model. In a client-server implementation a first executing software application (a “client”) passes data to a second executing software application (a “server”). That is, a client-server model is a distributed system in which software is separate between server tasks and client tasks. A client sends requests to a server, using a protocol, asking for information or action, and the server responds. Further, there can be either one centralized server or several distributed ones.

In client-server model, the client software application typically executes, but is not required to, on a separate physical computer unit (possibly with different hardware and/or operating system) than the server software application.

The current invention specifies a user providing input in order to change the “performance profile” of the applications running on the computer system. That is, the user selects which applications/processes/threads run faster and which will run slower. It should be apparent to one skilled in the relevant art(s), after reading the above description, however, that the invention can also be applied to any “entity” which requires a specific performance profile.

For example, consider the case of where the computer system includes a client-server software application executing in a distributed fashion within a network. In such a case, the client-side program can be the “entity” that provides the selection inputs, and thus be considered the “user” as described and used herein. That is, the client can instruct the server, via the present invention (e.g., via application table 700), to accelerate some processes 402 and decelerate others. The difference would be that instead of the (human) user providing input via the GUI 506 (and, for example, by using application performance table 700), the client would select the performance profile via a remote procedure call (RPC).

As is well known in the relevant art(s), an RPC is implemented by sending a request message to the server to execute a designated procedure, using arguments supplied, and a result message returned to the caller (i.e., the client). There are various protocols used to implement RPCs. Therefore, in the present invention, the RPC would specify which application 402 the client would like the server process to accelerate. The same would be true for the processes running on the server side. That is, the server could indicate to the client, using the present invention, which processes (i.e., applications 402) to accelerate and which to decelerate.

To illustrate the above embodiment, consider the case of a video streaming application 402 executing over a network. Typically, the client would request that video be downloaded. The server would send the video and possibly a Java applet to view the video. Using the present invention, the server can also send instructions to the present invention (i.e., IM 316) to assign a larger percentage of total system resources to the Java applet. The result would be a smoother playback of the downloaded video. In contrast, without the present invention, the client would have no indication as to how to handle the data and/or the applet being downloaded. Thus, the video data stream (which is time sensitive) is treated, by the client, like any other data. The network containing the client and server may accelerate the downloading of the video, but the present invention allows the assignment of system resources to the data being downloaded. In other words, the server can indicate if the data requires a larger or smaller percentage of the client's system resources.

In addition to the above, in an alternative embodiment of the present invention, the client-server can also send specific acceleration database information along with the data in order to accelerate the processing of the data. Consider, for example, the RealPlayer® Internet media streaming software application, available from RealNetworks, Inc. of Seattle, Wash. In addition to data, the server can also send information stored in database 510 (as described above) so that the RealPlayer® application's performance is increased. Thus, the present invention allows a Web server to differentiate itself from other servers that may be present in a network which simply carry data alone.

Further, in an alternative embodiment, the present invention can accept inputs from both a (human) user and a client-server (remote or local) program simultaneously. Consider, for example, the case where a user is running an application which is computation intensive (e.g., a Microsoft® Excel worksheet re-calculation). The user may then select this application to be assigned the most system resources (e.g., by using GUI 506). While the Excel application is executing, however, the user may decide to view video clips from the Internet. The server, as described above, will indicate (i.e., request) that the video applet get the most resources. But because the user has already selected the Excel process for getting the most resources, the present invention will apply the (AI) algorithms of the IM control logic 320 and database 510 inputs to provide both processes with the resources they need.

Conventional systems, in contrast, only allow the user to change the priority of the Excel application. There is no other functionality offered to a user that allows the acceleration of other processes. Thus, both the Excel application and video applet would be assigned the highest priority. This result defeats the purpose of changing the performance profile of the applications running on the computer system. In addition, accepting inputs from both the (human) user and remote processes gives the user some control over the assignment of resources via the application table 700. For example, in an embodiment, the user may select that a remote process only be allowed to use slots 4, 5, and 6 in the table 700 (see FIGS. 7A-C). This way, the remote process cannot take resources away from the processes the user wants accelerated. The system 500 as a whole, however, remains responsive to run-time demands for the allocation of resources.

VI. Remote Performance Management (RPM)

In an embodiment of the present invention, a remote performance management system is envisioned to be used in the distributed (client-server) computing environment described above, and having the functionality of the IM 316 as shown in flow 500 above.

A. Overview and Business Model

A Remote Performance Management (RPM) system, according to the present invention, allows client and server applications to cooperate in order to provide optimum quality of service support for the enhancement of the remote computing experience. RPM consists of clients and servers changing each other's performance profile to provide a more efficient use of resources. For example, a client may request that a server move resources to a database application, while the server may request the client to move resources to the processing of downloaded data.

In an embodiment, the RPM delivers control of the “network experience.” The following scenarios are examples: an Internet consumer who desires to improve the Internet multimedia experience; a content provider who wishes to differentiate itself from the other providers by offering a “premium service” or an enhanced Internet experience for all its customers; and dot com company (i.e., a content provider) who wishes to provide an enhanced advertising medium to its advertising customers (e.g., the provision of streaming video advertisements rather than animation to keep and influence Web browsing consumers).

The above-mentioned scenarios and different example implementation options for an IM service provider offering RPM services to accelerate (i.e., upgrade) distributed application performance are given in TABLE 9 below:

TABLE 9

| Scenario | Control | Billing | Authentication |
|---|---|---|---|
| Consumer | IM service provider | Consumer is billed | IM service provider |
| | upgrades based on | for performance upgrade | authenticates users |
| | authentication | | based on billing |
| Content Provider | IM service provider | Content provider is | Content provider |
| | upgrades based on | billed based on | authenticates user |
| | authentication from | amount of upgrades | and sends results to |
| | Content provider | | IM service provider |
| Advertisement | IM service provider | IM service provider | All users are |
| | upgrades based on | bills dot com based | upgraded. The ad |
| | input from ad seller | on upgrades, dot com | seller authenticates |
| | | bills ad buyer for | the ad which will be |
| | | premium service | enhanced |

In essence, the RPM system, in one embodiment of the present invention, would allow an IM service provider (ASP) to offer access, perhaps on a subscription or per-use basis, to a remote performance management tool (i.e., a remote IM 316) via the global Internet. That is, the IM service provider would provide the hardware (e.g., servers) and system software and database infrastructure, customer support, and billing mechanism to allow its clients (e.g., e-businesses, companies, business concerns and the like, who operate World Wide Web servers) to facilitate their content offerings to end user clients (i.e., consumers). Such billing mechanism, in one embodiment, would include a system for billing and record keeping so that authorized users may request performance enhancements and be easily charged on, for example, a per node basis. The RPM system would be used by such clients to remotely manage the resources of network nodes to increase performance in a network. Such management entails, in one embodiment, controlling which nodes get optimized either by a predefined list of authorized nodes or by specific request for individual nodes (requests for performance increase for a node can be made by the node itself or a by another node).

The RPM system of the present invention is described in greater detail below in terms of the above examples. This is for convenience only and is not intended to limit the application of the present invention. In fact, after reading the following description, it will be apparent to one skilled in the relevant art(s) how to implement the RPM system in alternative embodiments. For example, a LAN network manager utilizing the RPM system can enhance the use of corporate resources for corporate users. That is, the network manager can remotely configure some of the machines in the LAN to be efficient for video for a training program (or other corporate video broadcast), while other machines remain dedicated to some other task (e.g., digital circuit logic simulation).

B. RPM Architecture

In one embodiment of the RPM, consider a system consisting of a client, a server and a network with many nodes. The RPM system is designed to increase the performance of the system and distributed application as a whole. That is, the RPM system allows the server to control the resources on the nodes and client in a distributed application environment.

In a convention distributed application environment, the performance of the application depends on the allocation of resources that particular application gets from each and every resource in the network in order to gain a performance upgrade (i.e., an acceleration). That is, the application requires resources from the server, client and other nodes in the network in order to be accelerated. It is not enough to just have one element (e.g., the client) give the application a large number of resources. The server, the client and the nodes must cooperate to assign the application the resources the application requires in order to be accelerated.

As used herein, the term “distributed application” means any function which requires resources on both the server and the client. In this sense, even the downloading of raw data is considered “distributed” in this sense because it requires resources on both client and server.

Referring to FIG. 10, the system architecture 1000 of the RPM system, according to an embodiment of the present invention, is shown. Architecture 1000 and its associated processes are detailed below.

Architecture 1000 includes an RPM server 1002 that executes all functions required to balance the resources across the network. It also provides more resources to those users, or applications, which are authorized to receive those resources. In an embodiment, it is not necessary for the RPM server to run the server side of the distributed application, this can be executed by some other entity (e.g., a Web content provider's server 1004). The RPM server 1002 may then simply streamline the resources in order to optimize the distributed application.

The RPM server 1002 includes a Resource Allocation process that sends control information to each element in the computer network requesting the allocation of resources, and a Service Verifier process that verifies that only authorized users or applications authorized to receive enhanced performance actually get the resources they require.

The RPM server 1002 also includes a Billing process that keeps track of the resources assigned and generates appropriate billing information as suggested in TABLE 9 above.

A Remote Updater process functions to check the resource manager on each element in the network and updates the manager to the most efficient level.

An Application Server Communication process functions to communicate with the application servers in order to determine when and where to apply the resources.

RPM Architecture 1000 also includes, as will be apparent to those skilled in the relevant art(s), network nodes, which are elements in the network logically between the clients and the server (e.g., routers, switches, etc.). Each node may have its own resource allocator which reassigns the local resources based on requests from the RPM server 1002.

Within the RPM system architecture 1000, a client 1006 is the network node which functions as the client end of the distributed application. That is, it cooperates with the server end (i.e., Web server 1004) of the application to execute the function of the application. As suggested above, each client 1006 has its own resource allocator which reassigns the local resources based on requests from the RPM server 1002. Accordingly, the content provider executes the server side of the distributed application. A Service Authorization process functions to verify that the logged in user is authorized to receive the upgraded service from the content provider. A Service Requestprocess functions to send requests to the RPM server in order to enable a higher level of performance for the particular user running a particular application, and an RPM Server Communication process functions to allow the Web server 1004 to communicate with the RPM server 1002 so that resources can be allocated.

C. Example Implementations

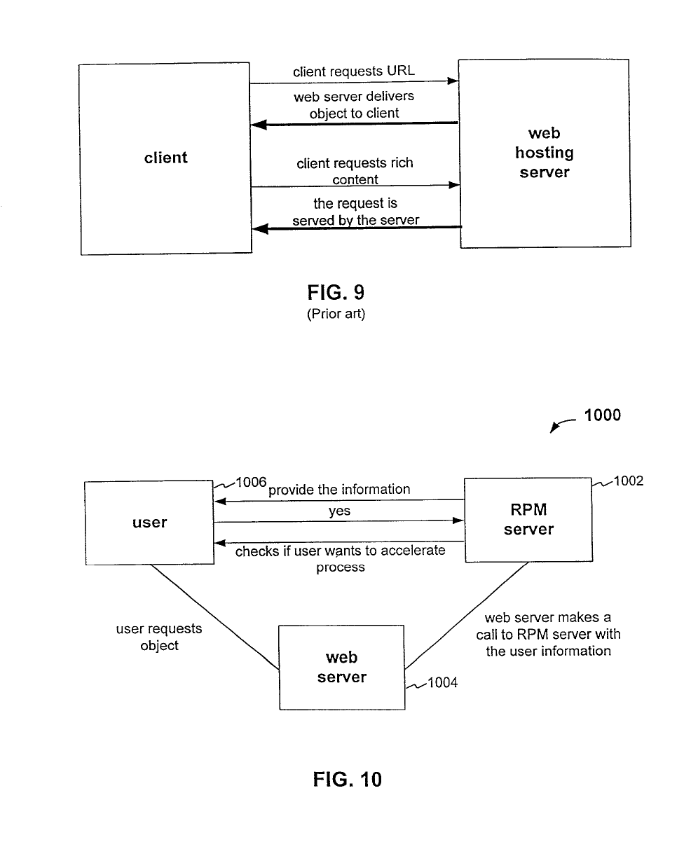

In the conventional client-server network, the normal flow of traffic consists of the (Web) server expecting user input and providing the user with required data. This is shown in the flow diagram of FIG. 9. A short-coming of such conventional networks is that there is no indication of how to treat data and all applications which are launched to handle such data are treated the same manner. The IM service provider, however, can enhance the network experience through the use of the RPM system of the present invention. The following three scenarios, referring again to FIG. 10, are examples.

In a first embodiment, a user connects directly to IM service provider's server 1002 and has a version of RPM system software running locally. The purpose of the connection is because the user desires to upgrade the distributed application offered by a content provider or make a request to RPM server 1002 to get the required information to do so. The server 1002 passes the control information to the user making a call to the client machine 1004. The RPM system software client reconfigures the machine 1006 for enhancing the network experience.

In a second embodiment, the user connects to RPM server 1002 and does not have a version of RPM system software. RPM server 1002 then queries the user on how he wishes to proceed. If the user indicates he would like to have the system optimized, the local client is downloaded. The flow then proceeds as in the first embodiment.

In a third embodiment, the user requests embedded objects and rich content from the Web server 1004. The Web server 1004 makes a call to RPM server 1002 with the IP address of the user machine 1006, and the relevant information of the embedded object the user has requested. The RPM server 1002 makes a call to the user to determine if the user desires to enhance their connection. If the answer is a yes, RPM server 1002 sends the relevant information to the user. If the user has the required databases and applications the connection proceeds as in the first embodiment. If not, the connection proceeds as in the second embodiment.

Without the user's knowledge, minimum control information is sent to the client machine 1006. A call from RPM server 1002 to the user's machine 1006 is made and minimum control information is transferred to the user, in the form of a Java applet, in one embodiment, which is capable of making a call to a dynamically linked library (DLL) in the target process. Further, the Web server 1004 wants the user to view the object in the best possible manner. Thus, the user would download the entire RPM system software and then control information can be passed to the user in the form of a call.

Referring to FIG. 11, a flow diagram 1100 illustrating the overall RPM operation of the present invention is shown. Flow 1100, as will be appreciated by those skilled in the relevant art(s), is similar to flow 500 described above, with the addition of the necessary steps for the RPM system to operate within the client-server paradigm. The Remote Authentication, Remote Application Reconfiguration, Remote Operating System Reconfiguration, Secure Machine to Machine Communication and Remote Machine Reconfiguration processes that comprise the RPM system (and floe 1100) are explained in greater detail below.

D. Remote Authentication

Executing on the RPM server 1002 are Remote Authentication processes that allow only authorized enhancements to occur on the client machine 1006. Services which have not been paid for will not be provided. This process blocks access to services and enables accesses to services which have authorized. Authorization comes from different sources and these processes also require secure communication and encryption.

Among the Remote Authentication processes are a Utility function and an IP Authentication function.

The Utility function runs on the Web server 1004 and starts the RPM system software on the RPM server 1002. This function makes a call to RPM server 1002 with the IP address of the user machine 1006 and the information on the objects the user wants to view. The input of the function is the IP address of the user and the information on the embedded data which it passes on to RPM server 1002. The information of the embedded object can be retrieved dynamically or can be maintained as a list on RPM server 1002. The IP address can be retrieved by the function itself, or passed to it by the Web server 1004. In one embodiment, the information is transferred to the RPM server 1002 by making a call using RPC/RMI/CORBA.

The IP Authentication function is distributed among the RPM server 1002, the Web server 1004, and the user (i.e., client machine 1006). The RPM server 1002 checks the IP address of the client, and accordingly provides services to the user. It checks to see if the user already has a version of RPM system software, by maintaining a list of IP addresses, and then passes the control information. This authentication also helps in the Billing process. RPM server 1002 will maintain a count and a list of all the IP addresses that the IM service provider provides the service to, and the class of service the client is authorized to receive. For example, the user may already have RPM system software, and just needs an upgrade. Thus, the IM service provider will either maintain the user IP address which can be checked, or the IM service provider will provide “keys” to client machine 1006. These keys will allow service package upgrades. The IM service provider maintains a database which consists of the list of the IP addresses and/or the keys. When the user comes directly to RPM server 1002, the user is provided with a key which may be used whenever service is needed. When the user comes through a Web server 1004 and the user needs rich content to be enhanced, then the IM service provider will maintain a list of the IP addresses and the class of service provided. This data can then be cross-checked with the service upgrades the user/content provider is given access to. This process is illustrated in FIG. 12.

Within the Web server 1004, the IP Authentication function allows the Web server 1004 to maintain a list of all the IP addresses which it directs to RPM server 1002. This helps the Web server 1004 in its own billing scheme.

Within the user's client machine 1006, the IP Authentication function allows the provision of a key or password if the user comes to IM service provider's site directly (i.e., connect to RPM Server 1002). The IM service provider saves the user's IP address in order to authenticate their identity next time they log on. If the user is directed by Web server 1004, RPM server 1002 maintains a list of their IP addresses. If the user was previously provided one-time service, and wants more service to be provided in the future, they will have to download RPM system software. Thus, they will get a key or password. TABLE 10 summarizes the above.

TABLE 10

| User Owns | User Logged | User Logged | | | |
|---|---|---|---|---|---|
| RPM | On to IM | Onto | | | |
| System | Service | Customer | Implementation | Billing | |
| Software | Provider | Site | Method | Method | Authenticate |
| Yes | No | Direct | RMI/IIOP, | 1. Web | 1. Maintain a |
| | | | SSL, | server | list of IP's |
| | | | CORBA, | billed | directed by |
| | | | RPC | | server |
| | | | | | 2. if user has to |
| | | | | | be given access |
| | | | | | to their regular |
| | | | | | service account |
| No | No | Direct | 1. | 1. Basic | 1. List of IPs |
| | | | RMI/IIOP, | service: | maintained |
| | | | SSL, | Web | 2. Maintain list |
| | | | CORBA, | server | of passwords |
| | | | RPC | billed | and usernames |
| | | | 2. | 2. | |
| | | | Download | Advanced | |
| | | | Necessary | service: | |
| | | | | download | |
| | | | | product | |
| | | | | and | |
| | | | | pay | |
| Yes | Direct | No | RMI/IIOP, | Does not | Check |
| | | | SSL, | pay | username and |
| | | | CORBA, | for | password |
| | | | RPC | upgrade | |
| No | Direct | No | Download | Has to | Maintain a list |
| | | | Necessary | download | of usemames |
| | | | | and pay | and passwords |
| | | | | according | |
| | | | | to the type | |
| | | | | of | |
| | | | | download | |

E. Remote Application Reconfiguration

This process allows for the reconfiguration of an application on a client machine 1006. The local IM service provider program responds to configuration requests from the RPM server 1002 and enhances the performance of the application based on the level of enhancement authorized for that user. This process is provided by the local client running on the customer's computer 1006. The local client, in one embodiment, consists of one or more of the following components: Control DLL, Graphical User Interface, Communication DLL, and a Java Applet.

F. Remote Operating System Reconfiguration

This process allows for the reconfiguration of the local operating system on a client machine 1006. The local IM service provider program responds to configuration requests from the RPM server 1002 and enhances the performance of the operating system based the level of enhancement authorized for that user. This process is provided by the local client running on the customer's computer 1006. The local client consists of, in one embodiment, one or more of the following components: Control DLL, Graphical User Interface, Communication DLL and Java Applet.

G. Secure Machine to Machine Communication

This process allows elements in the network to communicate updates and authorization information across the Internet. It is based on current encryption technologies but is geared mainly for machine to machine communication on a very low level (typically without user intervention).

This process provides the secure communication required for the RPM system to operate as described herein. This process may be implemented any one of several protocols. For example, in one embodiment, the secure sockets layer (SSL) protocol may be used. Distributed systems require that computations running in different address spaces, potentially on different hosts, be able to communicate. For a basic communication mechanism, the Java language supports sockets, which are flexible and sufficient for general communication. The process code logic would then be implemented, in one embodiment, using Java and C/C++. The IM service provider's application is written on its server 1002, each server type will have its own implementation.

In an alternate embodiment, the Remote Procedure Call (RPC) protocol may be used as an alternative to sockets. RPC abstracts the communication interface to the level of a procedure call. Instead of working directly with sockets, the programmer has the illusion of calling a local procedure, when in fact the arguments of the call are packaged and shipped to the remote target of the call. RPC systems encode arguments and return values using an external data representation, such as the eXternal Data Representation (XDR) data structure standard. RPC operates over UDP or TCP. RPC/UDP is a connection-less, stateless protocol. Although RPC/TCP is slower, it provides a reliable connection.

In other embodiments, the Java programing language Remote Method Invocation (RMI) library or the Common Object Request Broker Architecture (CORBA) standard may be utilized. In yet another embodiment, as suggested above (TABLE 10), RMI may be utilized in conjunction with the protocol known as the Internet Inter-ORB protocol (IIOP). IIOP is defined to run on transmission control protocol/internet protocol (TCP/IP). An IIOP request package contains the identity of the target object, the name of the operation to be invoked and the parameters. Thus RMI over IIOP (RMI/IIOP) combines the best features of RMI with the best features of CORBA as will be appreciated by those skilled in the relevant art(s).

H. Remote Machine Reconfiguration

The Remote Machine Reconfiguration process functions to change the configuration of client machine 1006 in order to enhance the performance of the machine. A local IM service provider program receives instructions from the RPM server 1002 and applies the changes. This process is provided by the local client running on the customer's computer 1006. The local client consists of, in one embodiment, one or more of the following components: Control DLL, Graphical User Interface, Communication DLL and a Java Applet.

VII. Example Implementations

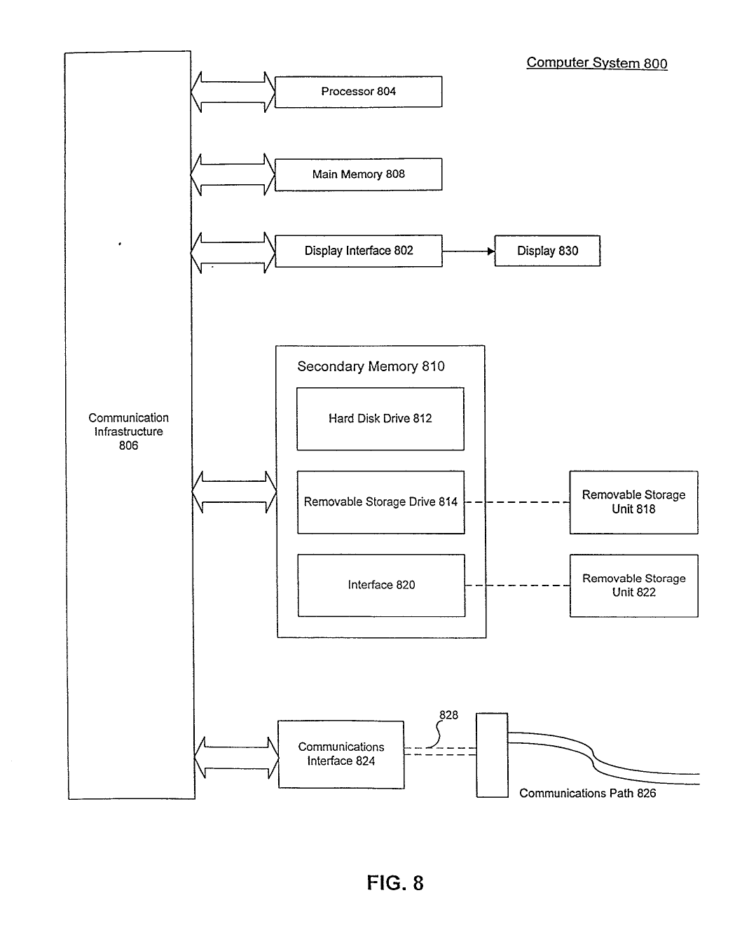

The present invention (i.e., system 500, the intelligent memory 316, remote performance management system 1000, flow 1100, or any part thereof) can be implemented using hardware, software or a combination thereof and can be implemented in one or more computer systems or other processing systems. In fact, in one embodiment, the invention is directed toward one or more computer systems capable of carrying out the functionality described herein. An example of a computer system 800 is shown in FIG. 8. The computer system 800 includes one or more processors, such as processor 804. The processor 804 is connected to a communication infrastructure 806 (e.g., a communications bus, cross-over bar, or network). Various software embodiments are described in terms of this exemplary computer system. After reading this description, it will become apparent to a person skilled in the relevant art(s) how to implement the invention using other computer systems and/or computer architectures.

Computer system 800 can include a display interface 805 that forwards graphics, text, and other data from the communication infrastructure 802 (or from a frame buffer not shown) for display on the display unit 830.

Computer system 800 also includes a main memory 808, preferably random access memory (RAM), and may also include a secondary memory 810. The secondary memory 810 may include, for example, a hard disk drive 812 and/or a removable storage drive 814, representing a floppy disk drive, a magnetic tape drive, an optical disk drive, etc. The removable storage drive 814 reads from and/or writes to aremovable storage unit 818 inawell known manner. Removable storage unit 818, represents a floppy disk, magnetic tape, optical disk, etc. which is read by and written to by removable storage drive 814. As will be appreciated, the removable storage unit 818 includes a computer usable storage medium having stored therein computer software and/or data.

In alternative embodiments, secondary memory 810 may include other similar means for allowing computer programs or other instructions to be loaded into computer system 800. Such means may include, for example, a removable storage unit 822 and an interface 820. Examples of such may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 can also include a communications interface 824. Communications interface 824 allows software and data to be transferred between computer system 800 and external devices. Examples of communications interface 824 can include a modem, a network interface (such as an Ethernet card), a communications port, a PCMCIA slot and card, etc. Software and data transferred via communications interface 824 are in the form of signals 828 which can be electronic, electromagnetic, optical or other signals capable of being received by communications interface 824. These signals 828 are provided to communications interface 824 via a communications path (i.e., channel) 826. This channel 826 carries signals 828 and can be implemented using wire or cable, fiber optics, a phone line, a cellular phone link, an RF link and other communications channels.

In this document, the terms “computer program medium” and “computer usable medium” are used to generally refer to media such as removable storage drive 814, a hard disk installed in hard disk drive 812, and signals 828. These computer program products are means for providing software to computer system 800. The invention is directed to such computer program products.

Computer programs (also called computer control logic) are stored in main memory 808 and/or secondary memory 810. Computer programs can also be received via communications interface 824. Such computer programs, when executed, enable the computer system 800 to perform the features of the present invention as discussed herein. In particular, the computer programs, when executed, enable the processor 804 to perform the features of the present invention. Accordingly, such computer programs represent controllers of the computer system 800.

In an embodiment where the invention is implemented using software, the software can be stored in a computer program product and loaded into computer system 800 using removable storage drive 814, hard drive 812 or communications interface 824. The control logic (software), when executed by the processor 804, causes the processor 804 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

VIII. Conclusion

While various embodiments of the present invention have been described above, it should be understood that they have been presented by way of example, and not limitation. It will be apparent to persons skilled in the relevant art that various changes in form and detail can be made therein without departing from the spirit and scope of the invention. Thus the present invention should not be limited by any of the above-described exemplary embodiments, but should be defined only in accordance with the following claims and their equivalents.

What is claimed is:

1. A method for providing remote performance management to increase the performance of applications executing in a distributed fashion within a computer network, comprising the steps of:
(1) receiving a request from a server within the computer network, said request specifying an application and the address of a client within said computer network;
(2) connecting to said client within said computer network;
(3) downloading, to said client, application data that contains profile information about said application; and
(4) downloading, to said client, control logic capable of using the information in said application data to determine a set of modifications to said client;
wherein said client can apply said control logic to make said set of modifications thereby allowing said application to more fully utilize the processing capabilities of the nodes within the computer network.

2. The method of claim 1, wherein step (1) is performed in response to said server receiving a request from said client for content via said application.

3. The method of claim 2, wherein said set of modifications include at least one of the following:
(i) modifications to said application executing on said client;
(ii) modifications to the operating system running on said client; and
(iii) modifications to the hardware within said client.

4. The method of claim 1, wherein said computer network is at least a portion of the Internet.

5. The method of claim 4, wherein the address of said client is an Internet Protocol (IP) address.

6. The method of claim 5, wherein said control logic downloaded to said client in step (4) is contained in a Java applet capable of making said set of modification by making a call to a dynamically linked library (DLL) on said server.

7. A method for providing a user with remote performance management capabilities to increase the performance of applications executing in a distributed fashion within a computer network, comprising the steps of:
(1) receiving a selection input from the user via a graphical user interface, said selection specifying a client within the computer network and an application that executes within the computer network;
(2) accessing an application database that contains profile data on said application;
(3) accessing a system database that contains configuration data about said client within the computer network;
(4) accessing control logic that uses said application data and said system data to determine a set of modifications;
(5) connecting to said client; and
(6) downloading, to said client, said application data and a portion of said control logic;
wherein said client can apply said portion of said control logic to make said set of modifications thereby allowing said application to more fully utilize the processing capabilities of the nodes within the computer network.

8. The method of claim 8, wherein said computer network is at least a portion of the Internet.

9. The method of claim 8, further comprising the step of: accessing a security database to determine whether the user is authorized to perform the selection of step (1).

10. A system for providing remote performance management to increase the performance of applications executing in a distributed fashion within a computer network, comprising:
(a) an application database that contains profile information on an application that executes within the computer network;
(b) a system database that contains configuration information about a client computer within the computer network;
(c) control logic that uses said application database and said system database to determine a set of modifications;
(d) means for receiving a request from a content server within the computer network, said request specifying said application and the address of said client computer;
(e) means for connecting to said client computer; and
(f) means for downloading, to said client computer, data from said application database and a portion of said control logic;
wherein said client computer can apply said portion of said control logic to make said set of modifications thereby allowing said application to more fully utilize the processing capabilities of the nodes within the computer network.

11. The system of claim 10, wherein said computer network is at least a portion of the Internet.

12. The system of claim 10, wherein said set of modifications include at least one of the following:
(i) modifications to said application executing on said client computer;
(ii) modifications to the operating system running on said client computer; and
(iii) modifications to the hardware within said client computer.

13. A computer program product comprising a computer usable medium having control logic stored therein for causing a computer to provide remote performance management to increase the performance of applications executing in a distributed fashion within a computer network, said control logic comprising:
first computer readable program code means for causing the computer to receive a request from a server within the computer network, said request specifying an application and the address of a client within said computer network;
second computer readable program code means for causing the computer to connect to said client within said computer network;
third computer readable program code means for causing the computer to download, to said client, application data that contains profile information about said application;
fourth computer readable program code means for causing the computer to download, to said client, control logic capable of using the information in said application data to determine a set of modifications to said client;
wherein said client can apply said control logic to make said set of modifications thereby allowing said application to more fully utilize the processing capabilities within the computer network.

14. The computer program product of claim 13, wherein said set of modifications include at least one of the following:
(i) modifications to said application executing on said client;
(ii) modifications to the operating system running on said client; and
(iii) modifications to the hardware within said client.

15. The computer program product of claim 13, wherein said control logic is contained in a Java applet capable of making said set of modification by making a call to a dynamically linked library (DLL) on said server.

16. A computer program product comprising a computer usable medium having control logic stored therein for causing a computer to provide a user with remote performance management capabilities to increase the performance of applications executing in a distributed fashion within a computer network, said control logic comprising:
first computer readable program code means for causing the computer to receive a selection input from the user via a graphical user interface, said selection specifying a client within the computer network and an application that executes within the computer network;
second computer readable program code means for causing the computer to access an application database that contains profile data on said application;
third computer readable program code means for causing the computer to access a system database that contains configuration data about said client within the computer network;
fourth computer readable program code means for causing the computer to access control logic that uses said application data and said system data to determine a set of modifications;
fifth computer readable program code means for causing the computer to connect to said client; and
sixth computer readable program code means for causing the computer to download, to said client, said application data and a portion of said control logic;
wherein said client can apply said portion of said control logic to make said set of modifications thereby allowing said application to more fully utilize the processing capabilities of the nodes within the computer network.
